(19) United States
(12) Patent Application Publication
(10) Pub. No.: US 2003/0074995 A1
(43) Pub. Date: Apr. 24, 2003

(54) Rack and pinion steering gear with pivoting yoke assembly

(75) Inventor: Scott C. Little, Bulls Gap, TN (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 10/034,804

(22) Filed: Oct. 19, 2001

(51) Int. Cl. B62D 3/12; F16H 55/18; F16H 1/04

(52) U.S. Cl. 74/422; 74/409

(57) ABSTRACT

A rack and pinion steering gear (10) comprises a housing (12). A pinion gear (22) rotatably mounted in the housing (12). Teeth (28) of the pinion gear (22) engage teeth of a rack bar (30) that extends through the housing (12) and that is movable relative to the housing (12). A yoke assembly (38) is located in the housing (12) for at least partially supporting and guiding movement of the rack bar (30) relative to the pinion gear (22). The yoke assembly (38) comprises a first member (46) for contacting the rack bar (30) and a second member (48) for pivotally supporting the first member (46). Structure (70) of the second member (48) engages structure (58) of the first member (46) to enable the first member (46) to pivot in all directions about a point of rotation (P). The point of rotation (P) is spaced from a location of engagement of the first and second members (46 and 48).

### TECHNICAL FIELD

The present invention relates to a rack and pinion steering gear and, more particularly, to a rack and pinion steering gear having a yoke assembly.

### BACKGROUND OF THE INVENTION

A known rack and pinion steering gear includes a pinion gear that is rotatably mounted in a housing and is connectable with a steering wheel of a vehicle. A rack bar extends through the housing and has opposite end portions that are connectable with steerable vehicle wheels. Gear teeth formed on the rack bar are disposed in meshing engagement with gear teeth on the pinion gear. A yoke assembly is disposed in the housing to support and guide movement of the rack bar relative to the housing. The yoke assembly includes a yoke bearing having an arcuate surface across which the rack bar moves. The support provided by the yoke assembly helps to ensure proper lash between the gear teeth of the rack bar and the gear teeth of the pinion gear.

### SUMMARY OF THE INVENTION

The present invention is a rack and pinion steering gear. The rack and pinion steering gear comprises a housing. A pinion gear is rotatably mounted in the housing. A rack bar extends through the housing and is movable relative to the housing. The rack bar has teeth in meshing engagement with teeth of the pinion gear. A yoke assembly is located in the housing for at least partially supporting and guiding movement of the rack bar relative to the pinion gear. The yoke assembly comprises a first member for contacting the rack bar and a second member for pivotally supporting the first member. Structure of the second member engages structure of the first member to enable the first member to pivot relative to the second member in all directions about a point of rotation. The point of rotation is spaced from a location of engagement of the first and second members.

According to another aspect, the rack and pinion steering gear comprises a housing. A pinion gear is rotatably mounted in the housing. A rack bar extends through the housing and is movable relative to the pinion gear. The rack bar has teeth in meshing engagement with teeth of the pinion gear. A yoke assembly is located in the housing for at least partially supporting and guiding movement of the rack bar relative to the pinion gear. The yoke assembly comprises a first member for contacting the rack bar and a second member for rotatably supporting the first member. A first one of the first and second members includes a pocket and a second one of the first and second members includes a protrusion that is receivable in the pocket. The pocket and the protrusion are partially spherical and allow pivoting of the first member relative to the second member in all directions.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a sectional view of a rack and pinion steering gear constructed in accordance with the present invention;

FIG. 2 is an enlarged view of a yoke bearing of the rack and pinion steering gear of FIG. 1;

FIG. 3 is a view taken along line 3-3 in FIG. 2;

FIG. 4 is a view similar to FIG. 2 and illustrating a second embodiment of the yoke bearing;

FIG. 5 is a view similar to FIG. 2 and illustrating a third embodiment of the yoke bearing; and

FIG. 6 is a view similar to FIG. 2 and illustrating a fourth embodiment of the yoke bearing.

### DETAILED DESCRIPTION OF THE INVENTION

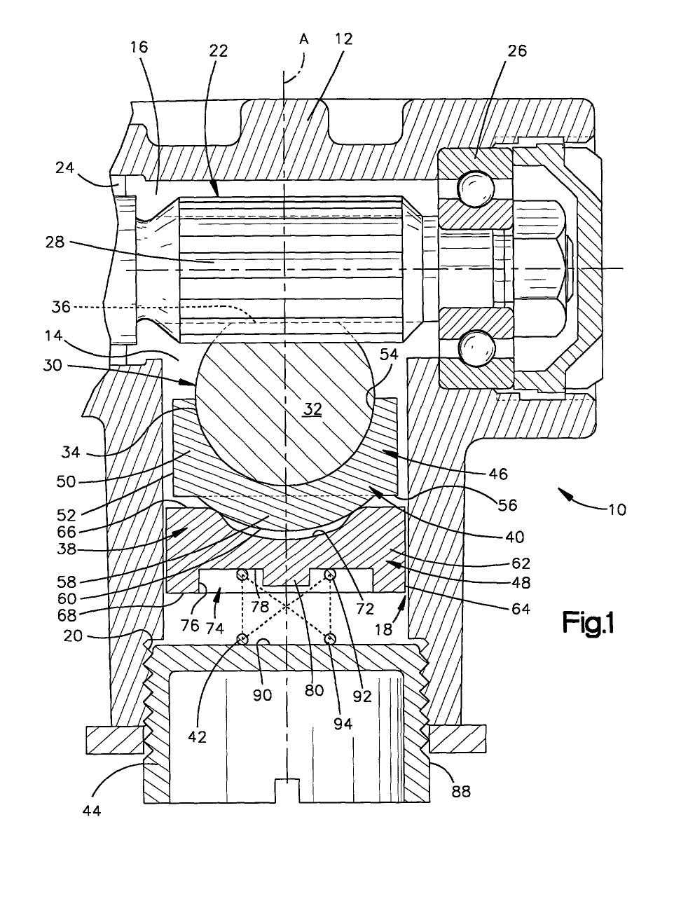

A sectional view of a rack and pinion steering gear 10 constructed in accordance with the present invention is illustrated in FIG. 1. The rack and pinion steering gear 10 includes a housing 12. Preferably, the housing 12 is made of cast metal. The housing 12 includes an axially extending passage 14, extending perpendicular to the plane of FIG. 1. A pinion passage 16 extends into the housing 12 and tangentially intersects the axially extending passage 14. A yoke bore 18 also extends into the housing 12 and connects with the axially extending passage 14. The yoke bore 18 extends in a direction perpendicular to the axially extending passage 14. In FIG. 1, axis A represents a central axis of the yoke bore 18. Axis A extends in a direction perpendicular to the axially extending passage 14. As shown in FIG. 1, the yoke bore 18 is located on a side of the axially extending passage 14 opposite the pinion passage 16. The yoke bore 18 terminates at a threaded opening 20.

A pinion gear 22 is located in the pinion passage 16 of the housing 12. Two bearing assemblies 24 and 26 rotatably support the pinion gear 22 in the housing 12. A first bearing assembly 24 is located at one end of the pinion gear 22. A second bearing assembly 26 is located at an opposite end of the pinion gear 22. A plurality of teeth 28 extends around the outer circumference of the pinion gear 22. The pinion gear 22 is connected with the vehicle steering wheel (not shown) in a known manner.

A portion of an axially extending rack bar 30 extends through the axially extending passage 14 of the housing 12. The rack bar 30 has opposite end portions (not shown) that are connected to the steerable wheels (not shown) of a vehicle through tie rods (not shown). The rack bar 30 has a generally cylindrical main body 32 having a generally circular outer surface 34. An upper surface 36 of the rack bar has a plurality of teeth (not shown). The plurality of teeth of the rack bar 30 is disposed in meshing engagement with the plurality of teeth 28 of the pinion gear 22.

A yoke assembly 38 is located within the yoke bore 18 of the housing 12. The yoke assembly 38 at least partially supports and guides movement of the rack bar 30 relative to the housing 12. The yoke assembly 38 comprises a yoke bearing 40, a spring 42, and a yoke plug 44.

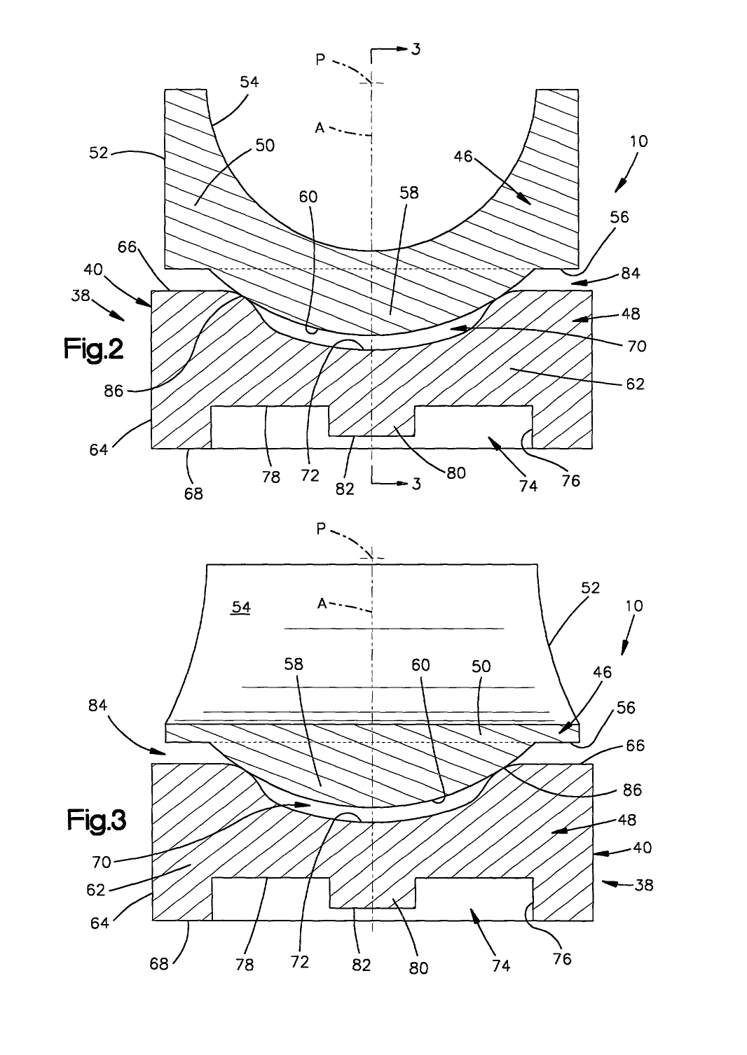

FIGS. 2 and 3 show enlarged views of the yoke bearing 40 of the yoke assembly 38. For clarity, the yoke bearing 40 in FIGS. 2 and 3 will be referred to with reference to axis A. The yoke bearing 38 includes first and second members 46 and 48, respectively. In one embodiment, the first and second members 46 and 48 are formed from zinc. Alternatively, the first and second members 46 and 48 may be formed from a polymer or thermoplastic material.

The first member 46 has a cylindrical main body portion 50 that includes a cylindrical side wall 52 and first and second surfaces 54 and 56, respectively. The cylindrical main body portion 50 has a diameter that is less than a diameter of the yoke bore 18. The first surface 54 of the main body portion 50 of the first member 46 is arcuate for contacting the outer surface 34 of the rack bar 30. In one embodiment, the arc of the first surface 54 is a dual radius arc so that line contact is established in the locations where the first surface contacts the outer surface 34 of the rack bar 30.

The second surface 56 of the main body portion 50 of the first member 46 is opposite the first surface 54 along axis A. The second surface 56 is generally flat and extends in a plane that is perpendicular to axis A. A partially spherical protrusion 58 is centered on the second surface 56 and extends outwardly of the second surface in a direction opposite the first surface 54. The protrusion 58 has a partially spherical outer surface 60. A circle is formed where the outer surface 60 of the protrusion 58 mates with the second surface 56 of the first member 46. The circle is centered on axis A. The second surface 56 extends radially, relative to axis A, outwardly of the protrusion 58.

The second member 48 also includes a cylindrical main body portion 62 that includes a cylindrical side wall 64 and opposite first and second surfaces 66 and 68, respectively. The diameter of the second member 48 is larger than the diameter of the first member 46 and is approximately equal to the diameter of the yoke bore 18. A seal (not shown) may extend around the side wall 64 of the second member 48 for creating a fluid-tight seal between the second member and a surface defining the yoke bore 18.

The first surface 66 of the second member 48 is generally flat and extends in a plane that is perpendicular to axis A. A partially spherical pocket 70 or recess extends from the first surface 66 into the main body portion 62 of the second member 48. The pocket 70 is defined by an inner surface 72. In the embodiment illustrated in FIG. 2, the inner surface 72 of the pocket 70 is a dual radius surface so that the inner surface forms an annular peak 86 within the pocket. An opening to the pocket 70 is circular and is located in the plane of on the first surface 66 of the second member 48. The opening is centered on axis A. The opening has a diameter that is less than the diameter of the circle that is formed where the protrusion 58 of the first member 46 meets the second surface 56 of the first member 46.

The second surface 68 of the second member 48 is generally flat and extends in a plane that is parallel to the plane of the first surface 66. A recess 74 extends from the second surface 68 into the main body portion 62 of the second member 48. An opening to the recess 74 is circular and is located in the plane of the second surface 68 of the second member 48. The circular opening is centered on axis A. A side wall 76 and an end wall 78 define the recess 74. The side wall 76 extends perpendicular to the second surface 68 and the end wall 78 extends parallel to the second surface 68. A cylindrical spring guide 80 extends outward of the end wall 78 of the recess 74. The spring guide 80 is centered on axis A and terminates at an end wall 82 that is located within the recess 74.

When the yoke bearing 40 is assembled, the protrusion 58 of the first member 46 is inserted into the pocket 70 of the second member 48. When the outer surface 60 of the protrusion 58 engages inner surface 72 of the pocket 70, a gap 84 (FIGS. 2 and 3) separates the second surface 56 of the first member 46 from the first surface 66 of the second member 48. Since the inner surface 72 of the pocket 70 is a dual radius surface, the outer surface 60 of the protrusion 58 engages the annular peak 86 of the inner surface 72 of the pocket 70. As a result, the area of contact between the first and second members 46 and 48 is annular or ring-shaped. Preferably, the diameter of the annular area of contact between the first and second members 46 and 48 is greater than one-half the diameter of the opening on the first surface 66 of the second member 48. The larger the diameter of the annular area of contact, the more stable the first member 46 is relative to the second member 48.

When supported by the second member 48 of the yoke bearing 40, the first member 46 of the yoke bearing may be pivoted in any direction. The first member 46 pivots about a point P that would form the center of the protrusion 58. The pivot point P in FIG. 2 is located on axis A, above the second surface 56 of the first member 46. A width of the gap 84 between the second surface 56 of the first member 46 and the first surface 66 of the second member 48 determines an amount of pivotal movement of the first member relative to the second member. When the second surface 56 of the first member 46 contacts the first surface 66 of the second member 48, further pivotal movement of the first member in that particular direction is prevented. Preferably, the first member 46 may pivot by about ten degrees, relative the second member 48, in every direction. During the pivotal movement of the first member 46 relative to the second member 48, the area of contact between the first and second members remains annular and remains located at the peak 86 of the inner surface 72 of the pocket 70 of the second member 48.

The yoke plug 44 is shown in FIG. 1. The yoke plug 44 is cylindrical and includes a threaded outer surface 88 and a generally flat end surface 90. Although not shown in FIG. 1, a cylindrical spring guide may extend outwardly, along axis A, of the end surface 90 of the yoke plug 44. The spring 42 of the yoke assembly 38 illustrated in FIG. 1 is a helical compression spring. The spring 42 has a first axial end 92 and a second axial end 94. The spring 42 also has a known spring constant.

To assemble the yoke assembly 38 into the rack and pinion steering gear 10, the first member 46 of the yoke bearing 40 is inserted into the yoke bore 18 so that the first surface 54 of the first member contacts the rack bar 30 on a side of the rack bar opposite the pinion gear 22. The second member 48 of the yoke bearing 40 is then inserted into the yoke bore 18 so that the protrusion 58 from the second surface 56 of the first member 46 is received in the pocket 70 of the first surface 66 of the second member. The first axial end 92 of the helical spring 42 is then inserted into the recess 74 on the second surface 68 of the second member 48. The first axial end 92 of the spring 42 engages the end wall 82 of the recess 74 and the spring guide 80 is received in the spring. The yoke plug 44 is then screwed into the yoke bore 18. The end surface 90 of the yoke plug 44 engages the second axial end 94 of the spring 42. The yoke plug 44 is screwed into the yoke bore 18 a distance sufficient to place a predetermined bias on the yoke bearing 38.

During operation of the rack and pinion steering gear 10, the rack bar 30 moves through the axially extending passage 14 of the housing 12 to turn the steerable wheels of the vehicle. During this movement, the rack bar 30 may also move in a direction perpendicular to the axially extending passage 14. The yoke assembly 38 supports the rack bar 30 during this movement and helps to maintain engagement of the rack bar with the pinion gear 22.

During movement of the rack bar 30, the first member 46 of the yoke bearing 40 pivots relative to the second member 48 of the yoke bearing. The first member 46 pivots to a position that provides the least resistance or interference to movement of the rack bar 30. Since the diameter of the main body portion 50 of the first member 46 is smaller than the diameter of the yoke bore 18, the yoke bore does not interfere with the pivotal movement of the first member. Preferably, the pivot point P of the first member 46 corresponds to the center of the rack bar 30. Thus, the outer surface 34 of the rack bar 30 will not interfere with or limit the pivotal movement of the first member 46 about point P.

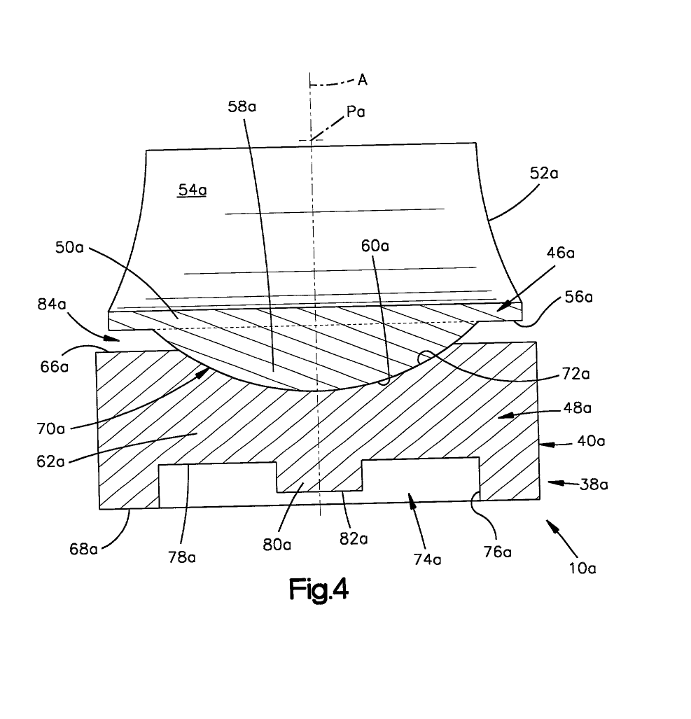

FIG. 4 shows a second embodiment of the yoke bearing 40a of the yoke assembly 38a of the rack and pinion steering gear 10a constructed in accordance with the present invention. Portions of the yoke bearing 40a of FIG. 4 that are the same as, or similar to, portion of the yoke bearing 40 illustrated in FIGS. 2 and 3 have the same reference numerals with the suffix “a” attached.

The yoke bearing 40a of FIG. 4 is identical to the yoke bearing 40 of FIGS. 2 and 3 with the exception that the inner surface 72a defining the pocket 70a on the first surface 66a of the second member 48a is not a dual radius surface. The inner surface 72a has the same radius as the partially spherical protrusion 58a that extends from the second surface 56a of the first member 46a. Thus, when the second member 48a supports the first member 46a, the area of contact between the first and second members is also partially spherical and is approximately equal to the area of the inner surface 72a of the pocket 70a.

The yoke bearing 40a of FIG. 4 functions in the same manner as the yoke bearing 40 of FIGS. 2 and 3. However, since the area of contact between the first and second members 46a and 48a of the yoke bearing 40a is greater than the area of contact in the yoke bearing 40, frictional resistance to the pivotal movement of the first member 46a relative to the second member 48a is greater in yoke bearing 40a. This frictional resistance may be combated by forming the outer surface 60a of the protrusion 58a and the inner surface 72a of the pocket 70a from a low friction material, such as Teflon coated Bronze, or by placing a lubricant, such as grease, between the two surfaces.

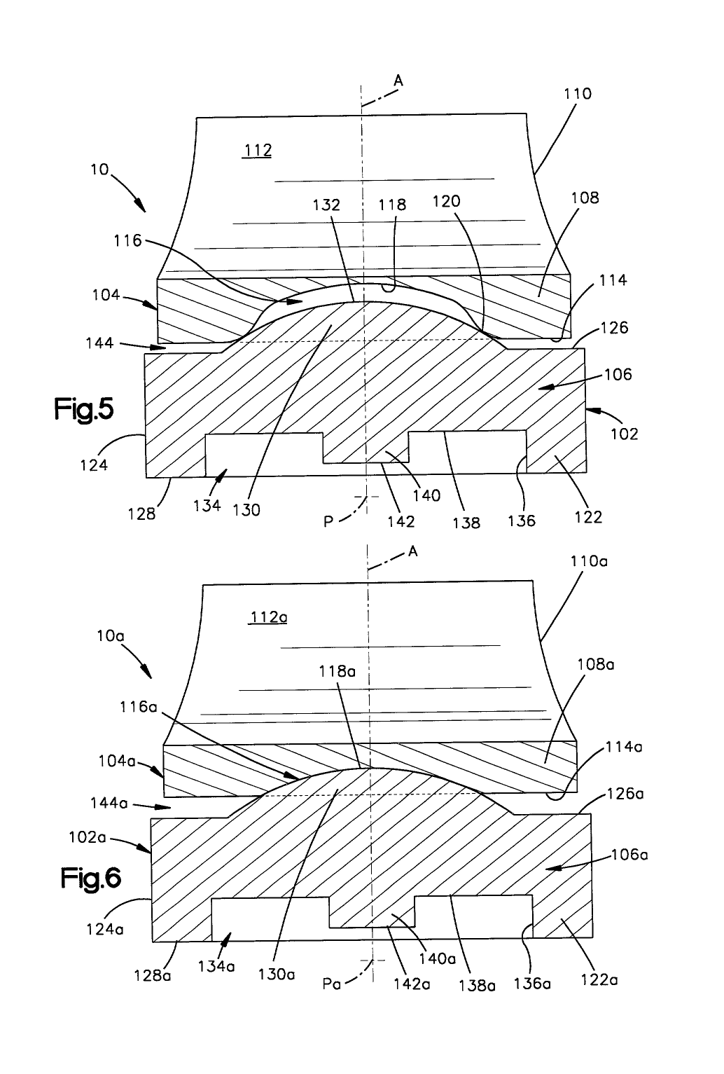

FIG. 5 shows a third embodiment of the yoke bearing 102 of the rack and pinion steering gear 10 constructed in accordance with the present invention. Structure of the rack and pinion steering gear 10 not shown in FIG. 5 will be referred to using the same reference numerals as was used in FIG. 1. The yoke bearing 102 of FIG. 5 includes first and second members 104 and 106, respectively.

The first member 104 of the yoke bearing 102 has a cylindrical main body portion 108 that includes a cylindrical side wall 110 and opposite first and second surfaces 112 and 114, respectively. The cylindrical main body portion 108 has a diameter that is less than a diameter of the yoke bore 18. The first surface 112 is arcuate for contacting the rack bar 30. In one embodiment, the arc of the first surface 112 is a dual radius arc so that line contact is established in the locations where the first surface contacts the rack bar 30. The second surface 114 is generally flat and extends in a plane that is perpendicular to axis A. A partially spherical pocket 116 or recess extends from the second surface 114 and into the main body portion 108 of the first member 104. The pocket 116 is defined by an inner surface 118. In the embodiment illustrated in FIG. 5, the inner surface 118 of the pocket 116 is a dual radius surface so that an annular peak 120 is formed on the inner surface within the pocket. An opening to the pocket 116 is circular and is located in the plane of the second surface 114 of the first member 104. The opening is centered on axis A.

The second member 106 also includes a cylindrical main body portion 122. The main body portion 122 of the second member 106 includes a cylindrical side wall 124 and opposite first and second surfaces 126 and 128, respectively. The diameter of the second member 106 is larger than the diameter of the first member 104 and is approximately equal to the diameter of the yoke bore 18. The first surface 126 of the second member 106 is generally flat and extends in a plane that is perpendicular to axis A. A partially spherical protrusion 130 is centered on the first surface and extends outwardly of the first surface 126 in a direction opposite the second surface 128. The protrusion 130 has a partially spherical outer surface 132. A circle is formed where the outer surface 132 of the protrusion 130 mates with the first surface 126 of the second member 106. The circle has a diameter that is greater than the diameter of the opening of the pocket 116 in the second surface 114 of the first member 104. The circle is centered on axis A. The first surface 126 of the second member 106 extends radially, relative to axis A, outwardly of the protrusion 130.

The second surface 128 of the second member 106 is generally flat and extends in a plane that is parallel to the plane of the first surface 126. A recess 134 extends from the second surface 128 into the main body portion 122 of the second member 106. An opening to the recess 134 is circular and is located in the plane of the second surface 128 of the second member 106. The opening to the recess 134 is centered on axis A. A side wall 136 and an end wall 138 define the recess 134. The side wall 136 extends perpendicular to the second surface 128 and the end wall 138 extends parallel to the second surface 128. A cylindrical spring guide 140 extends outward of the end wall 138 of the recess 134. The spring guide 140 is centered on axis A and terminates at an end wall 142 that is located within the recess 134.

When the yoke bearing 102 is assembled, the protrusion 130 of the second member 106 is inserted into the pocket 116 of the first member 104. When the outer surface 132 of the protrusion 130 of the second member 106 engages inner surface 118 of the pocket 116 of the first member 104, a gap 144 separates the second surface 114 of the first member 104 from the first surface 126 of the second member 106. Since the inner surface 118 of the pocket 116 is a dual radius surface, the outer surface 132 of the protrusion 130 engages the peak 120 of the inner surface 118 of the pocket 116. As a result, the area of contact between the first and second members 104 and 106 is annular or ring-shaped. Preferably, the diameter of the annular area of contact between the first and second members 104 and 106 is greater than one-half the diameter of the opening on the second surface 114 of the first member 104. The larger the diameter of the annular area of contact, the more stable the first member 104 is relative to the second member 106.

When supported by the second member 106 of the yoke bearing 102, the first member 104 of the yoke bearing may be pivoted in any direction. The first member 104 pivots about a point P that would form the center of the spherical protrusion 130. Thus, the pivot point P in FIG. 5 is located on axis A, below the first surface 126 of the second member 106. The gap 144 between the second surface 114 of the first member 104 and the first surface 126 of the second member 106 determines the amount of pivotal movement of the first member 104 relative to the second member 106. When the second surface 114 of the first member 104 contacts the first surface 126 of the second member 106, further pivotal movement of the first member 104 in that particular direction is prevented. Preferably, the first member 104 may pivot by about ten degrees, relative to the second member 106, in every direction. During the pivotal movement of the first member 104 relative to the second member 106, the area of contact between the first and second members 104 and 106 remains annular and remains located at the peak 120 of the inner surface 118 of the pocket 116 of the first member 104.

FIG. 6 shows a fourth embodiment of the yoke bearing 102a of the rack and pinion steering gear 10a constructed in accordance with the present invention. Portions of the yoke bearing 102a of FIG. 6 that are the same as, or similar to, portion of the yoke bearing 102 illustrated in FIG. 5 have the same reference numerals with the suffix “a” attached.

The yoke bearing 102a of FIG. 6 is identical to the yoke bearing 102 of FIG. 5 with the exception that the inner surface 118a defining the pocket 116a on the second surface 114a of the first member 104a is not a dual radius surface. The inner surface 118a also has the same radius as the partially spherical protrusion 130a from the first surface 126a of the second member 106a. Thus, when the second member 106a supports the first member 104a, the area of contact between the first and second members 104a and 106a is also partially spherical and is approximately equal to the area of the inner surface 118a of the pocket 116a.

The yoke bearing 102a of FIG. 6 functions in the same manner as the yoke bearing 102 of FIG. 5. However, since the area of contact between the first and second members 104a and 106a of the yoke bearing 106a is greater than the area of contact in the yoke bearing 102, frictional resistance to the pivotal movement of the first member 104a relative to the second member 106a is greater in yoke bearing 102a. This frictional resistance may be combated by forming the outer surface 132a of the protrusion 130a and the inner surface 118a of the pocket 116a from low friction material or by placing a lubricant, such as grease, between the two surfaces.

From the above description of the invention, those skilled in the art will perceive improvements, changes and modifications. For example, although a pivotal movement of about ten degrees between the first and second members of the yoke bearing is preferred, it should be realized that the present invention is not limited to pivotal movement of about ten degrees and that other angles of pivotal movement are contemplated by this invention. Such improvements, changes and modifications within the skill of the art are intended to be covered by the appended claims.

Having described the invention, I claim the following:

1. A rack and pinion steering gear comprising:
a housing;
a pinion gear rotatably mounted in the housing;
a rack bar extending through the housing and being movable relative to the housing, the rack bar having teeth in meshing engagement with teeth of the pinion gear; and
a yoke assembly located in the housing for at least partially supporting and guiding movement of the rack bar relative to the pinion gear,
the yoke assembly comprising a first member for contacting the rack bar and a second member for pivotally supporting the first member, structure of the second member engaging structure of the first member to enable the first member to pivot, relative to the second member, in all directions about a point of rotation, the point of rotation being spaced from a location of engagement of the first and second members.

2. The rack and pinion steering gear of claim 1 wherein the structure of the first member includes one of a protrusion and a pocket and the structure of the second member includes the other of the protrusion and the pocket.

3. The rack and pinion steering gear of claim 2 wherein the pocket is defined by a dual radius surface and the protrusion is partially spherical, an area of contact between the protrusion and the dual radius surface being annular.

4. The rack and pinion steering gear of claim 3 wherein the point of rotation is located at a center of the partially spherical protrusion.

5. The rack and pinion steering gear of claim 2 wherein the pocket is defined by a partially spherical surface and the protrusion is partially spherical, an area of contact between the protrusion and the surface being partially spherical.

6. The rack and pinion steering gear of claim 5 wherein the point of rotation is located at a center of the partially spherical protrusion.

7. The rack and pinion steering gear of claim 1 wherein a diameter of the first member is less than a diameter of the second member.

8. The rack and pinion steering gear of claim 1 wherein the point of rotation coincides with a center of a cross-section of the rack bar.

9. The rack and pinion steering gear of claim 1 wherein pivotal movement of the first member relative to the second member is limited by a surface of the first member contacting a surface of the second member.

10. A rack and pinion steering gear comprising:
a housing;
a pinion gear rotatably mounted in the housing;
a rack bar extending through the housing and being movable relative to the pinion gear, the rack bar having teeth in meshing engagement with teeth of the pinion gear; and
a yoke assembly located in the housing for at least partially supporting and guiding movement of the rack bar relative to the pinion gear,
the yoke assembly comprising a first member for contacting the rack bar and a second member for rotatably supporting the first member, a first one of the first and second members including a pocket and a second one of the first and second members including a protrusion that is receivable in the pocket, the pocket and the protrusion being partially spherical and allowing pivoting of the first member relative to the second member in all directions.

11. The rack and pinion steering gear of claim 10 wherein the pocket is defined by a dual radius surface and the protrusion is partially spherical, an area of contact between the protrusion and the dual radius surface being annular.

12. The rack and pinion steering gear of claim 11 wherein the point of rotation is located at a center of the partially spherical protrusion.

13. The rack and pinion steering gear of claim 10 wherein an area of contact between the protrusion and the surface is partially spherical.

14. The rack and pinion steering gear of claim 10 wherein the point of rotation is located at a center of the partially spherical protrusion.

15. The rack and pinion steering gear of claim 10 wherein a diameter of the first member is less than a diameter of the second member.

16. The rack and pinion steering gear of claim 10 wherein the point of rotation coincides with a center of a cross-section of the rack bar.

17. The rack and pinion steering gear of claim 10 wherein pivotal movement of the first member relative to the second member is limited by a surface of the first member contacting a surface of the second member.
